(19) United States
(12) Patent Application Publication
(10) Pub. No.: US 2018/0263728 A1
(43) Pub. Date: Sep. 20, 2018

(54) MATRIX RING FOR TOOTH RESTORATION

(71) Applicant: Young Microbrush, LLC, Grafton, WI (US)

(72) Inventors: John Frymark, Chicago, IL (US); Eri Hino, Chicago, IL (US); Richard Gaggioli, Greenfield, WI (US); John Boos, Grand Haven, MI (US); Robert E. Kreutzer, JR., Columbia, IL (US)

(21) Appl. No.: 15/463,232

(22) Filed: Mar. 20, 2017

(51) Int. Cl. A61C 5/85

(52) U.S. Cl. CPC A61C 5/85; A61C 2201/007

(57) ABSTRACT

A matrix ring includes a body that has a yoke, a first side arm extending from a first end of the yoke, a second side arm extending from a second end of the yoke, a first tine extending downwardly and inwardly from the first side arm, and a second tine extending downwardly and inwardly from the second side arm and converging toward the first tine. A first tip covers at least a portion of the first tine, and a second tip covers at least a portion of the second tine. The first and second tips are each bifurcated by a tine gap to provide a first tip finger and a second tip finger.

### BACKGROUND

In the field of dentistry, mercury has historically been used as a filler material to fill a hole in a tooth sometimes referred to as a “restorative area” which may be the result of a chipped tooth or excavation of decayed portions of the tooth. More recently, however, composite resins are used to fill a restorative area and provide a more natural looking tooth filling which is typically less toxic than mercury. Once applied to a restorative area, the composite resin is cured, typically by the application of concentrated light.

Sometimes, a restorative area extends to one or more side surfaces of a tooth. To place a composite resin filling in a restorative area that extends to a side surface of the tooth, a dentist or dental professional typically places a dental matrix (referred to herein as a “matrix band” or a “band”) against the tooth side surface defining the restorative area. The band forms a boundary that acts to contain the composite resin or other filler material (“filler material”) in the restorative area prior to curing. Bands are generally formed of plastic, stainless steel or both and are either circumferential or sectional. Sectional bands fit only in one interproximal area of the tooth while circumferential bands (sometimes call “tofflemire” bands) fit around the entire periphery of the tooth.

Sectional bands must be held in place to create an effective boundary for the filler material. Sectional bands are typically held in place by wedges and/or matrix rings. Wedges may be inserted between the band and an adjacent tooth and help force the band against the tooth being filled along the gingiva. Depending on their design, wedges can also serve to temporarily separate the tooth being filled from the adjacent tooth. Matrix rings hold the sectional band against the tooth being filled by clamping the band against opposing sides of the tooth.

### BRIEF DESCRIPTION OF THE DRAWINGS

The following figures are included to illustrate exemplary embodiments of certain aspects of the present disclosure and should not be viewed as exclusive embodiments. The subject matter disclosed is capable of considerable modifications, alterations, combinations, and equivalents in form and function, without departing from the scope of this disclosure.

FIG. 1A is an isometric view of an example matrix ring.

FIG. 1B is an isometric view of the matrix ring of FIG. 1A with tips on the tines.

FIG. 2 is a top view of the matrix ring of FIG. 1B.

FIG. 3 is a front view of the matrix ring of FIG. 1B.

FIG. 4 is a side view of the matrix ring of FIG. 1B.

FIG. 5A is an isometric front view of the matrix ring of FIG. 1B in an exemplary installation within a patient's mouth.

FIG. 5B is an isometric top-side view of a tip of the matrix ring of FIG. 1B.

FIG. 5C is an isometric bottom-side view of a tip of the matrix ring of FIG. 1B.

FIG. 5D is a cross-sectional front view of the matrix ring of FIG. 1B depicting an exemplary location of the matrix ring body within the tips.

FIG. 5E is a cross-sectional front view of the matrix ring of FIG. 1B in an exemplary installation within a patient's mouth and depicting an exemplary location of the matrix ring body within the tips.

FIG. 6 is a side view of the matrix ring of FIG. 1B in exemplary installation within a patient's mouth.

### SUMMARY OF THE DISCLOSURE

A matrix ring comprising a body that includes a yoke, a first side arm extending from a first end of the yoke, a second side arm extending from a second end of the yoke, a first tine extending downwardly and inwardly from the first side arm, the first tine being bifurcated into a first tip finger and a second tip finger to define a first tine gap; and a second tine extending downwardly and inwardly from the second side arm and converging toward the first tine, the second tine being bifurcated into a third tip finger and a fourth tip finger to define a second tine gap; a first tip covering at least a portion of the first tine; and a second tip covering at least a portion of the second tine. The body can comprise a material selected from the group consisting of super elastic BB nitinol, stainless steel and titanium. The first and second tips can each comprise a material selected from the group consisting of silicone, liquid silicone rubber, polypropylene or nylon. The yoke can comprise an arcuate transition member forming a convex curve between the first and second side arms. The first side arm can extend substantially parallel to the second side arm. The first and second side arms can extend from the yoke at a first angle, and first and second tines can extend from the first and second side arms, respectively, at a second angle, and the first and second angles can range between 75° and 105°. The first and second side arms can each include a first curve and a second curve, and wherein the first curve is convex and the second curve is concave. The first and second tips can each comprise a top surface that transitions into a front surface, and a back surface that transitions into a bottom surface, and wherein the bottom surface and the front surface of each tip converge toward each other until terminating at a distal edge. The entire front surface portion can be bifurcated into a first front surface portion defined on the first tip finger and a second front surface portion defined on the second tip finger. The top surface of each tip can be angled downwardly at a first angle relative to horizontal and the front surface can be angled downwardly at a second angle relative to horizontal, and wherein the second angle can be greater than the first angle. The back surface of each tip can b angled downwardly at an angle relative to horizontal and the bottom surface extends parallel with horizontal. The body can define two halves having mirror symmetry of one another about a line of symmetry; and the first tip can comprise a front surface configured to contact one or more teeth or a band, the front surface forming an angle of approximately 15 degrees with the line of symmetry. The first tip can comprise a front surface configured to contact one or more teeth or a band and a bottom surface forming an angle of approximately 75 degrees with the front surface at the distal edge.

A tip configured for an arm of a matrix ring, the tip comprising a top surface that transitions into a front surface configured to contact one or more teeth or a band; and a back surface that transitions into a bottom surface; wherein the bottom surface and the front surface meet at a distal edge. The entire front surface portion can be bifurcated into a first front surface portion and a second front surface portion, defining a gap there between. An inwardly concave depression can be defined at a lateral edge on at least one of the first front surface portion and the second front surface portion. The top surface can be angled downwardly at a first angle relative to horizontal and the front surface can be angled downwardly at a second angle relative to horizontal, and wherein the second angle is greater than the first angle. The back surface of each tip can be angled downwardly at an angle relative to horizontal and the bottom surface can extend substantially parallel with horizontal. The bottom surface can meet the front surface at angle of approximately 75 degree to form the distal edge. The tip can be configured for association with a matrix ring body defining two halves having mirror symmetry of one another about a line of symmetry and the front surface forming an angle of approximately 15 degrees with the line of symmetry. The tip can be comprised of a material selected from the group consisting of silicone, liquid silicone rubber, polypropylene or nylon.

A matrix ring comprising a body that includes a yoke, a first side arm extending from a first end of the yoke, the first side arm defining a first curve extending from adjacent to the first end of the yoke and a second curve extending from adjacent to the first curve, the first curve of the first side arm is upwardly convex and the second curve of the first side arm is downwardly convex; and a second side arm extending from a second end of the yoke, the second side arm defining a first curve extending from adjacent to the second end of the yoke and a second curve extending from adjacent to the second side arm first curve, the first curve of the second side arm is upwardly convex and the second curve of the second side arm is downwardly convex. The yoke can define an arcuate transition member. The matrix ring can further comprise a first tine extending from the first side arm, the first tine being bifurcated into a first tip finger and a second tip finger to define a first tine gap. The body can be comprised of a material selected from the group consisting of super elastic BB nitinol, stainless steel and titanium. The first side arm can be substantially parallel to the second side arm. The first and second side arms can extend from the yoke at a first angle, and first and second tines can extend from the first and second side arms, respectively, at a second angle, and wherein the first and second angles range between 75° and 105°. The first curve of the first side arm can have a radius of curvature of approximately 0.122 inches and the second curve of the first side arm can have a radius of curvature of approximately 0.122 inches. The first and second curves of the first side arm can space the yoke 0.20 inches from a distal end of the second curve of the first side arm.

A matrix ring comprising a body having a first side arm terminating in a first distal tip and a second side arm terminating in a second distal tip; a first tip covering the first distal tip of the first side arm, the first tip defining a front surface configured to contact one or more teeth; a second tip covering the second distal tip of the second side arm, the second tip defining a front surface configured to contact one or more teeth; the first tip begin configured such that the maximum pressure applied by the first tip front surface to the one or more teeth is located below the first distal tip. The second tip can be configured such that the maximum pressure applied by the second tip front surface is located below the second distal tip. The first distal tip can be defined by a first tine bifurcated into a first tip finger and a second tip finger can define a first tine gap. The body can define two halves having mirror symmetry of one another about a line of symmetry, and the first tip front surface an angle of approximately 15 degrees with the line of symmetry. The first tip can define a bottom surface forming an angle of approximately 75 degrees with the front surface at a distal edge of the first tip. The body can comprise a material selected from the group consisting of super elastic BB nitinol, stainless steel and titanium. The first tip can comprise a material selected from the group consisting of silicone, liquid silicone rubber, polypropylene or nylon. The first tip can define a top surface that transitions into the front surface, and a back surface that transitions into a bottom surface, and the bottom surface and the front surface converge toward each other until terminating at a distal edge. The bottom surface and front surface can form an angle of approximately 75 degrees at the distal edge. The entire front surface of the first tip can be bifurcated into a first front surface portion defined on the first tip finger and a second front surface portion defined on the second tip finger.

A matrix ring comprising a body comprising a yoke; a first side arm extending from a first end of the yoke to a first tine and defining a first cross-sectional area adjacent the yoke and a second cross-sectional area adjacent the first tine, wherein the second cross-sectional area is smaller than the first cross-sectional area; a second side arm extending from a second end of the yoke to a second tine and defining a third cross-sectional area adjacent the yoke and a fourth cross-sectional area adjacent the second tine, wherein the fourth cross-sectional area is smaller than the third cross-sectional area; a first tip covering the first tine, the first tip defining a front surface configured to contact one or more teeth; and a second tip covering the second tine, the second tip defining a front surface configured to contact one or more teeth. The cross-sectional area of the first arm can continually decrease from the first cross-sectional area to the second cross-sectional area. The cross-sectional area of the second arm can continually decrease from the third cross-sectional area to the fourth cross-sectional area. The yoke can comprise an arcuate transition member forming a convex curve between the first and second side arms. The first tine can be bifurcated into a first finger and a second finger to define a first tine gap and the second tine can be bifurcated into a third finger and a fourth finger to define a second tine gap. The body can comprise a material selected from the group consisting of BB nitinol, stainless steel and titanium. The first side arm can extend substantially parallel to the second side arm. The first and second side arms can extend from the yoke at a first angle, and first and second tines can extend from the first and second side arms, respectively, at a second angle, and wherein the first and second angles range between 75 degrees and 105 degrees. The first and second side arms can each include a first curve and a second curve, and wherein the first curve is convex and the second curve is concave.

A method of replacing tips on a matrix ring comprising a body having a first side arm having a first tip for contacting teeth and a second side arm having a second tip for contacting teeth, the method comprising the steps of i) removing the first tip from the first side arm; and ii) securing a replacement tip to the first side arm. The step of removing the first tip from the first side arm can comprise at least cutting the first tip from the first arm. The step of removing the first tip from the first side arm can comprise at least melting the first tip from the first arm. The step of securing a replacement tip to the first side arm can comprise at least overmolding the replacement tip to the first side arm. The step of securing a replacement tip to the first side arm can comprise securing a replacement tip comprising the same material and configuration as the first tip. The step of securing a replacement tip to the first side arm can comprise securing a replacement tip comprising a configuration different from the configuration of the first tip.

### DETAILED DESCRIPTION

The present disclosure is related to certain tools used in the field of dentistry and, more particularly, to novel designs for matrix rings, and portions thereof, used to hold a band against one or more teeth to provide a barrier holding filler material in a restorative area.

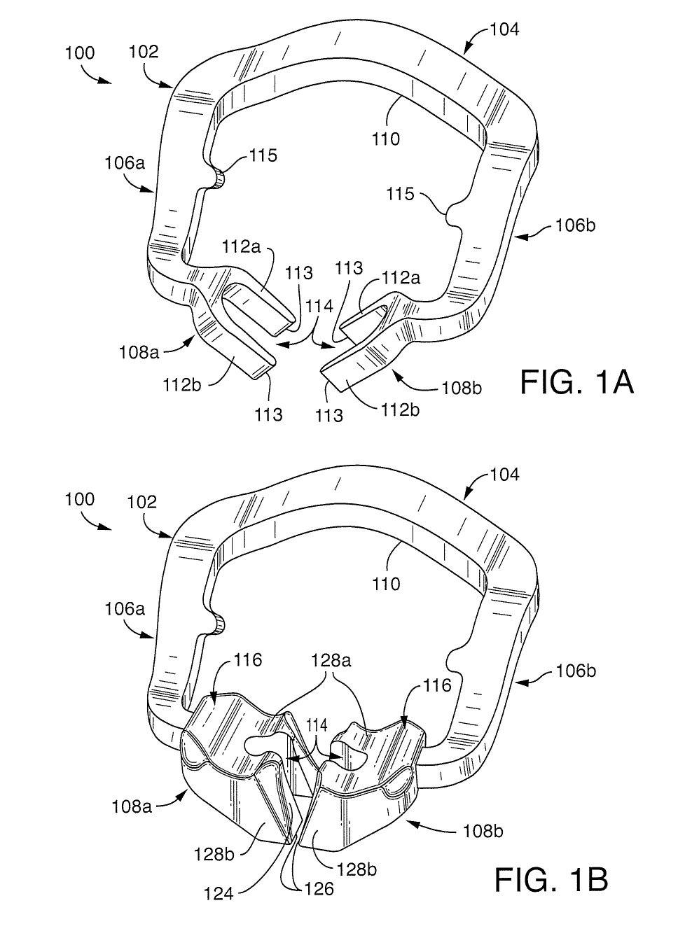

FIG. 1B is an isometric view of an example matrix ring 100, according to one or more embodiments of this disclosure. This exemplary matrix ring 100 is comprised of a matrix ring body 102 (sometimes referenced herein as the “body”) and a pair of tips 116. FIG. 1A is an isometric view of an exemplary embodiment of the body 102. The body 102 can be made of a variety of semi-rigid and/or elastic materials. The body 102 may be made of, for example, super elastic BB nitinol or stainless steel. In other embodiments, however, the body 102 may be made of titanium, or a thermoplast or thermoset, a polymer or other elastic materials.

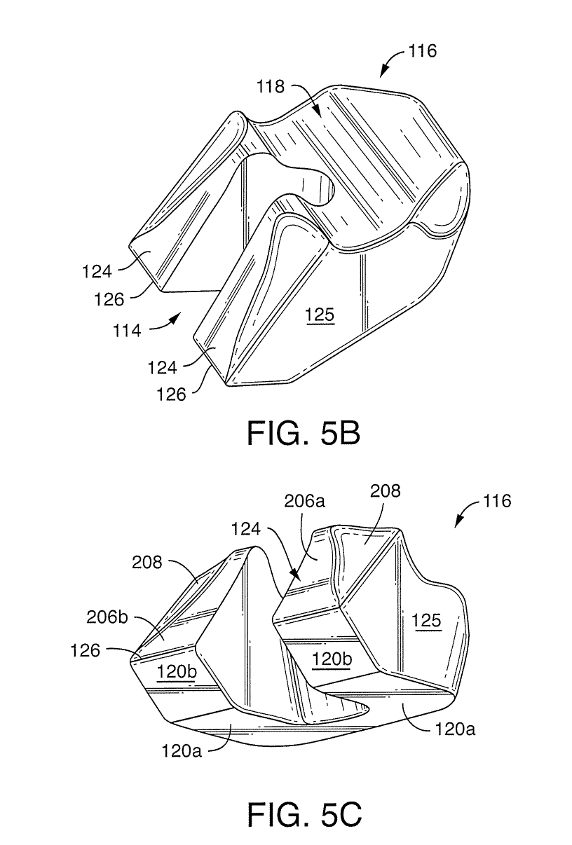

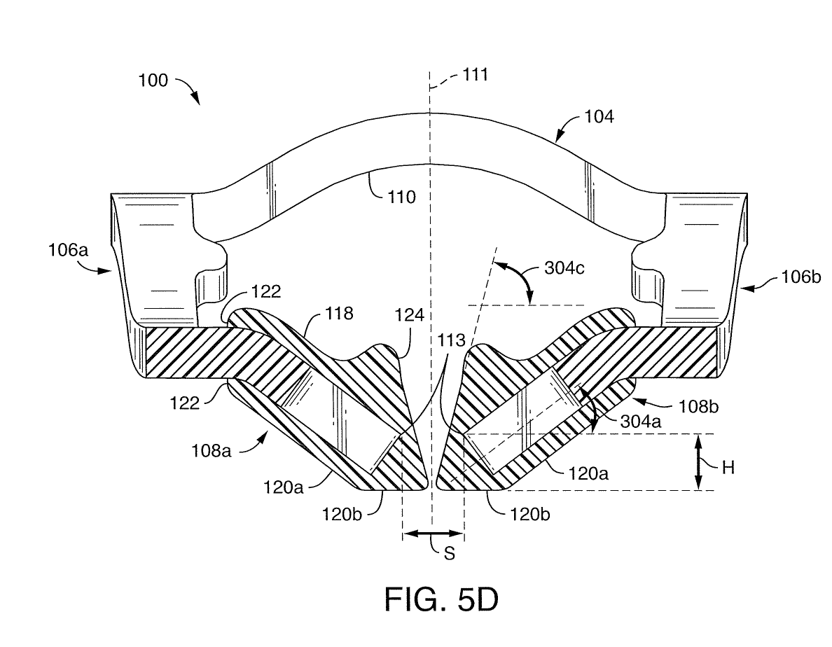

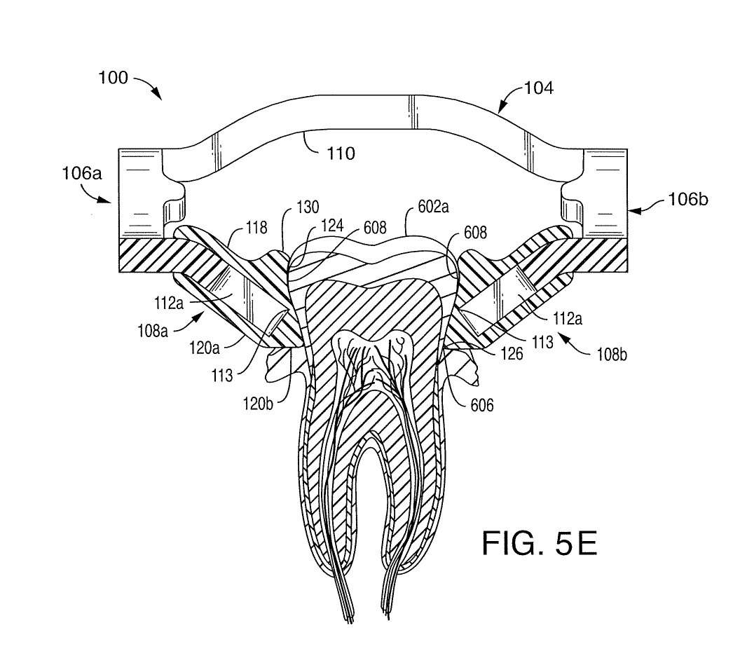

As illustrated, the body 102 includes a yoke 104, a first side arm 106a, a second side arm 106b, a first tine 108a, and a second tine 108b. The yoke 104 provides a structural transition between the first and second side arms 106a,b on opposing sides of the body 102. More specifically, the yoke 104 comprises a generally arcuate transition member 110 that extends laterally between the first and second side arms 106a,b with an upwardly convex curvature defined by a radius of curvature 302 (identified in FIG. 3). The first side arm 106a extends from a first end of the yoke 104 and the second side arm 106b extends from a second end of the yoke 104. In the depicted embodiment, the body 102 is comprised of two halves having mirror symmetry of one another about a line of symmetry 111 (identified in FIG. 5D) running through the apex of the curvature of the transition member 110. Other embodiments in which the halves are not mirror images of each other are also contemplated.

In the depicted embodiment, the first and second side arms 106a,b extend substantially parallel to each other on opposing sides of the body 102. As used herein with reference to the first and second side arms 106a,b, the phrase “substantially parallel” can refer to a truly parallel geometric relationship between the first and second side arms 106a,b, but may alternatively refer to a geometric relationship where the first and second side arms 106a,b slightly converge or slightly diverge relative to the other. Either “substantially parallel” scenario is contemplated in the present disclosure, and may depend on the size of teeth to which the matrix ring 100 will be applied and/or the material of the body 102. Other embodiments in which the side arms 106a,b are not substantially parallel are also contemplated.

The first and second tines 108a,b extend downwardly and inwardly relative to the first and second side arms 106a,b, respectively. As depicted in FIG. 1A, each tine 108a,b provides a forked structure that includes a first finger 112a and a second finger 112b. The first and second fingers 112a,b of each tine 108a,b define a tine gap 114 therebetween. In the depicted embodiment, the tine gap 114 is generally U-shaped, but other configurations are contemplated as as well. The fingers 112a,b of each tine 108a,b extend parallel to each other and converge downwardly toward the fingers 112a,b of the opposing tine 108a,b. Each finger 112a,b defines a distal tip 113 which, but for the tips 116, would define the location of force applied by the body 102 against a patient's tooth or matrix band. As described in more detail below, the tine gap 114 provides a location where a dental practitioner may insert a wedge (not shown) to be extended between adjacent teeth in the mouth of a patient. The overall shape of the depicted embodiment of the matrix ring body 102 is configured generally as an open-ended rectangle (open between the tines), which differs from the generally circular shape of most prior matrix rings. The term “ring”, then, should not limit the shape of the disclosed matrix ring 100 to a circular, round or other shape.

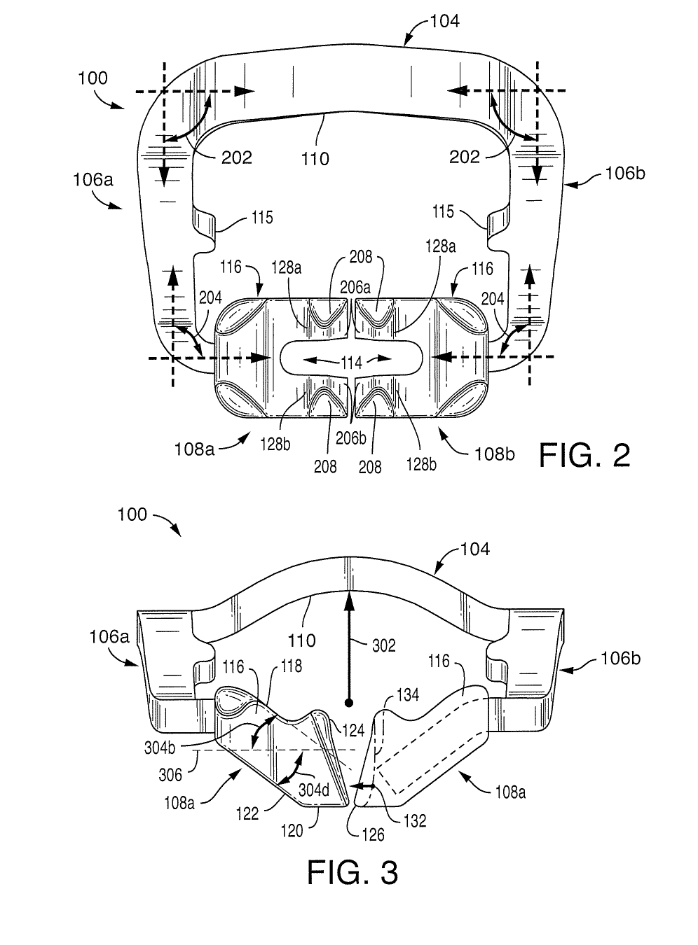

FIG. 2 is a top or plane view of the matrix ring 100 of FIG. 1B. As illustrated, the yoke 104 structurally transitions to the first and second side arms 106a,b at a first angle 202. More particularly, the first and second side arms 106a,b extend from the transition member 110 of the yoke 104 at the first angle 202. In some embodiments, the first angle 202 may be about 90° such that the first and second side arms 106a,b are substantially orthogonal to the transition member 110. The first angle 202, however, may alternatively range between about 75° and about 105° such that the first and second side arms 106a,b converge or diverge relative to one another. Moreover, in some embodiments, as illustrated, the transition between the yoke 104 and the first and second side arms 106a,b is not abrupt with sharp inner and outer corners, but instead preferable defines curved transition surfaces. Although the depicted embodiment shows the two first angles 202 being equal to one another, other embodiments in which those angles are not equal are also contemplated.

The first and second side arms 106a,b structurally transition to the first and second tines 108a,b, respectively, which turn inward toward each other at a second angle 204 to turn the tines 108a,b to contact one or more teeth. More particularly, the first and second tines 108a,b extend from the first and second side arms 106a,b, respectively, at the second angle 204. In some embodiments, the second angle 204 may be about 90° such that the first and second tines 108a,b are substantially orthogonal to the first and second side arms 106a,b. The second angle 204 may alternatively range between about 75° and about 105°. Although the depicted embodiment shows the two second angles 204 being equal to one another, other embodiments in which those angles are not equal are also contemplated. When the first 202 and second 204 angles are all 90° or approximately 90°, such as in the depicted exemplary embodiments, the matrix ring 100 is configured in the general shape of an open-ended rectangle in which the yolk 104 comprises one side of the rectangle, the side arms 106a,b define opposing second and third sides of the rectangle and the tips 116 form a partial fourth side leaving an opening between the tips 116.

FIG. 3 is a front view of the matrix ring 100 of FIG. 1B. As illustrated, the yoke 104 provides an upwardly convex curve extending between the first and second side arms 106a,b. The transition member 110 of the yoke 104 defines the radius of curvature 302, which, in some embodiments, may be constant along all or a portion of the transition member 110. In other embodiments, however, the radius of curvature 302 may vary, without departing from the scope of the disclosure. In one embodiment, the radius of curvature is 0.35 inches. Other radii of curvature are within the scope of this disclosure.

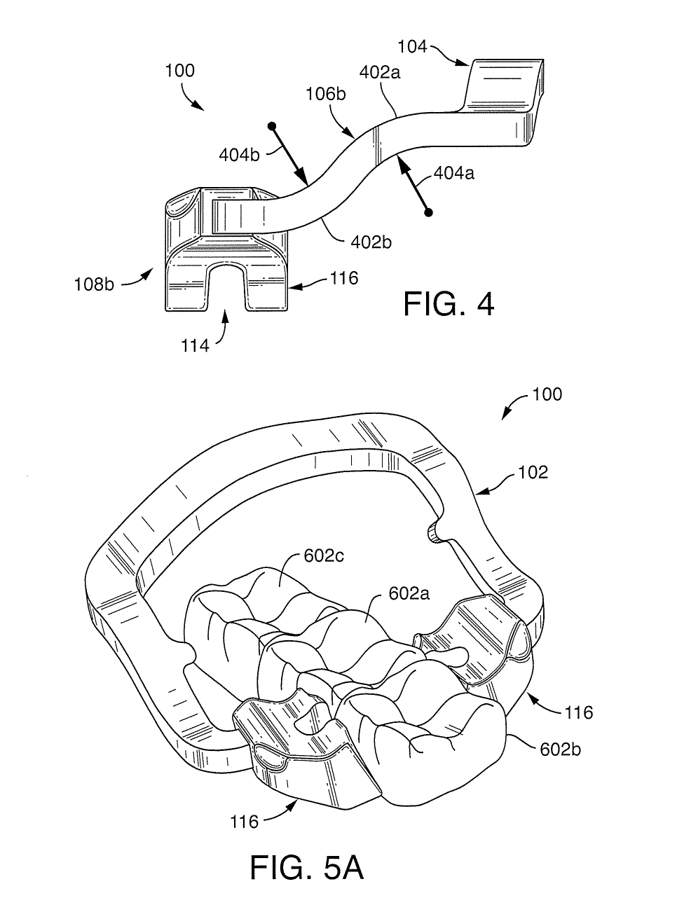

FIG. 4 is a side view of the matrix ring 100 of FIG. 1B. More particularly, FIG. 4 depicts a side view of the second side arm 106b, which extends between the yoke 104 and the second tine 108b. While the discussion of FIG. 4 focuses on the second side arm 106b, it will be appreciated that the present discussion is equally applicable to the first side arm 106a in the depicted embodiment. As illustrated, the second side arm 106b extends from the yoke 104 approximately horizontally and then turns downward from horizontal defining a first curve 402a having a radius of curvature 404a. At or adjacent to the end of the first curve 402a, the second side arm 106b turns back upward toward horizontal defining a second curve 402b having a radius of curvature 404b. The direction of curvature of the first curve 402a is opposite the direction of curvature for the second curve 402b and the first curve 402a may be characterized as a convex curve while the second curve 402b may be characterized as a concave curve. The first and second curves 402a,b may alternatively be referred to herein as “bends” in the second side arm 106b. The first and second curves 402a,b are contiguous portions of the second side arm 106b. In the illustrated embodiment, the first and second radii of curvature 404a,b are equal and the curves 402a,b are of equal length so that the second curve 402b brings the second side arm 106b back to approximately horizontal (as defined by the angle at which the side arm 106b leaves the yoke 104). In other embodiments, however, the length of the first and second arms 402a,b and/or the value of the first and second radii of curvature 404a,b may be dissimilar.

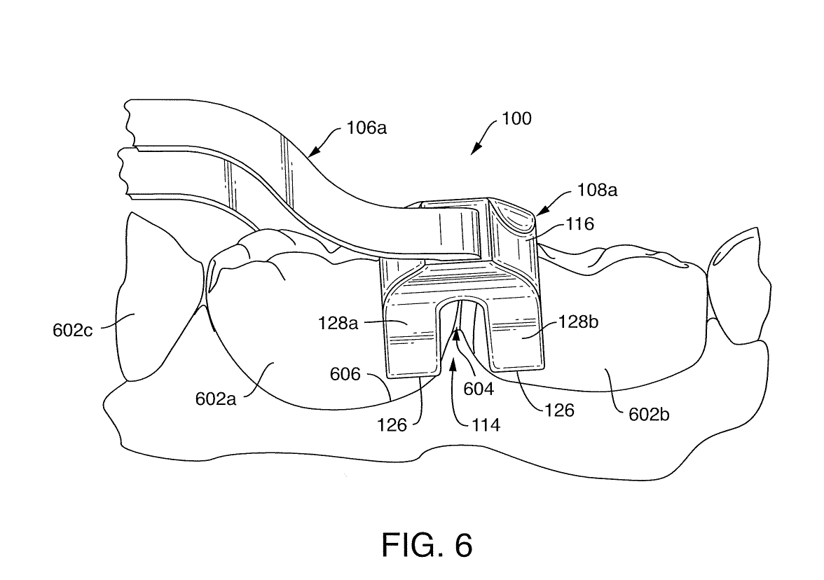

As can be seen in FIG. 6, the second curve 402b elevates the first curve 402a and the yoke 104 above the patient's teeth. In this configuration, the end of the second curve 402b adjacent the tips 116 can be approximately horizontal and the end of the first curve 402a adjacent the yoke 104 can also be approximately horizontal, as depicted, while the yoke 104 is elevated above the patients teeth (e.g. third tooth 602c in FIG. 6). In this way, the side arms 106a,b extend laterally along opposing sides (i.e., inner and outer sides) of the teeth and elevate the yoke 104 so that it may extend over the top of the teeth. Prior art matrix rings were often designed such that a portion of the ring rested on the teeth and, if a dental practitioner inadvertently bumped the prior art matrix ring during use, the teeth could act as a fulcrum point that caused the prior art matrix ring to disengage from the teeth (often called “spring off”). The curves 402,b of each side arm 106a,b of the depicted embodiment elevate the yoke 104 up above the patient's teeth (e.g. third tooth 602c in FIG. 6), lessening the likelihood of the yoke 104 contacting a tooth. The curvature of the yoke 104 may also provide additional clearance between the yoke and the teeth.

The length of the second curve 402b may be short and/or the second curve radius of curvature 404b may be short so that the second curve end adjacent to the first curve 402a may be located above the tooth contacted by the tip 116 (e.g. first tooth 602a). In this configuration, the second curve 402b quickly elevates the first curve 402a and the yoke 104, to clear all teeth. In the depicted embodiment, the first and second curves 402a,402b each have a radius of curvature of 0.122 inches and together elevate the yoke 0.20 inches. This elevation provides space to install a second matrix ring against an adjacent tooth (e.g. third tooth 602c). In this way, the configuration of the matrix ring 100 arms 106a,b of the present disclosure facilitates nesting of multiple such matrix rings 100 to facilitate application to adjacent tooth gaps. Other lengths, curvatures and elevations are within the scope of this disclosure to accomplish the advantages discussed herein.

As shown in FIG. 1B, all or a portion of each tine 108a,b may be overmolded, encapsulated or otherwise covered with one tip 116. The tips 116 may be made of a flexible or supple material to distribute clamping force from the body 102 across the surface of one or more teeth and/or a band. In one embodiment, for example, the tips 116 may be made of silicone, such as liquid silicone rubber. In another embodiment, the tips 116 comprise a 75-85 Durometer silicone, with a preference for an 80 Durometer silicone. In other embodiments, however, the tips 116 may be made of other supple materials such as, but not limited to, rubber and other plastic elastomers, polypropylene, nylon and other materials know in the art for comprising matrix ring tips or combinations thereof.

In some embodiments, the tips 116 may be overmolded onto the tines 108a,b. In other embodiments, however, the tips 116 may be secured to the tines 108a,b by ultrasonic welding or other welding, clipping, adhesive or other known methods of securing matrix ring tips to a matrix ring body. Any of these methods may also be used for securing replacement tips to a matrix ring body. For example, used, worn, dirty, unsterile or otherwise undesirable tips may be removed from a matrix ring such as, by way of example only, cutting and removing the tips or melting the tips from the body. Replacement tips may then be secured onto the ring by any of the methods mentioned above or other known methods. The replacement tips may be of a different material and/or configuration than the removed tips to provide the matrix body with different tips than prior to the replacement. Alternatively, the one or both of the tines 108a,b are removably secured to the remainder of the body 102 such as by screwing or other manners of removably securement so that replacement of the tips 116 could be accomplished by first removing the removable first and second tines 108a,b from the body 102 which necessarily take the associated tips 116 with them, and second, by securing new tines 108a,b having tips 116 to the body 102.

As depicted in FIG. 5B and FIG. 5C, each tip 116 provides a top surface 118, an outer bottom surface 120a, an inner bottom surface 120b, a back surface 122, a front surface 124 and opposing side surfaces 125. The inner bottom surface 120b and the front surface 124 of each tip 116 converge toward each other until terminating at a distal edge 126. The distal edge 126 constitutes the portion of each tip 116 closest in proximity to the opposing tip 116. When using the matrix ring 100 in a patient's mouth, the distal edge 126 is the first portion of each tip 116 that engages a band, one or more teeth or the gingival margin.

The tip 116 of each respective tine 108a,b covers the corresponding fingers 112a,b depicted in FIG. 1A. Consequently, each tip also defines the tine gap 114, albeit to a smaller magnitude because of the volume of material required to constitute the tips 116. Moreover, each tine gap 114 bifurcates the tip 116 into a first tip finger 128a and a second tip finger 128b as shown, for example, in FIG. 6. The first and second tip fingers 128a,b encapsulate the first and second fingers 112a,b. The depicted embodiment covers the entirety of each U-shaped tine 108a,b with the tip 116. Other configurations are also contemplated. In one exemplary alternative embodiment, the tip covers only portions of the tine fingers 112a,b. For example, the tip 116 could cover only a portion of the tine finger distal tips 113 of one tine 112a or 112b. In this alternative embodiment, the remainder of the depicted tip 116 would not be present.

FIG. 5A is an isometric front view of the matrix ring 100 of FIG. 1B in example operation within a patient's mouth, according to one or more embodiments. A boss 115 extends inward from each side arm 108a,b approximately where the first and second curves 402a,b meet. Forceps, or another dental tool, can be located on the side arms 108a,b for spreading the side arms 108a,b apart and to allow placement of the matrix ring 100 on a patient's teeth. In the depicted embodiment, the boss is a hemispherical nub extending inward from the side arms 108a,b, but other configurations are also contemplated. As depicted in FIG. 5A, the tips 116 contact the patient's teeth on the teeth inner and outer edges. Because the tips 116 comprise first and second tip fingers 128a,b defining a gap 114 along the entire tip front surface 124, the gap 114 is aligned with a gap 604 between the patient's teeth. The clamping force of the matrix ring 100 is therefore directed to the patients teeth 602a,b, not into the tooth gap 604 between those teeth 602a,b. As a result, the tips 116 are not wedged into the tooth gap 604 as with some prior art matrix rings and the teeth 602a,b are not wedged or otherwise forced apart.

As indicated above, each tine 108a,b extends downwardly and inwardly with respect to the corresponding first and second side arms 106a,b, respectively. In the embodiment depicted in FIG. 5D, the second tine 108b is depicted as extending downwardly from the second side arm 106b at a third angle 304a. The first tine 108a similarly extends downwardly from the first side arm 106a at an angle equal to angle 304a, but could be varied in alternate embodiments. In one embodiment, the third angle 304a is approximately 45°. In other embodiments, the angle is approximately 37° or anywhere between approximately 37° and 45°.

Although the upwardly convex curvature of the yoke 104 provides some clearance to avoid contact with a patient's teeth (e.g. third tooth 602c), the upwardly convex curvature of the yoke 104 also provides an increased clamping force between the tips 116 of the matrix ring 100 over the clamping force that would be provided by a flat yoke. The distance between the distal edges 113 of the two first tine fingers 112a defines a spread S. When the matrix ring 100 is in a relaxed state, such as that depicted in FIGS. 3 and 5D, the spread S is intentionally smaller than the width of the teeth of the intended patient. In order to install the matrix ring 100 to a patient's teeth, the spread S must first be increased so that the space between the tips 116 is large enough to place the tips 116 on opposing sides of the patient's teeth and/or band and/or gingival, as depicted in FIGS. 5A and 6. Increasing the spread S beyond its relaxed stated flexes the first and second side arms 106a,b outward to create a horizontal inward clamping force applied to the patients teeth and/or band and/or gingival. Increasing the spread S beyond its relaxed state also flexes the upwardly concave curvature of the yoke 104, slightly flattening that yoke 104 (as depicted in FIG. 5E), creating a downward and inward clamping force that in addition to the horizontal inward clamping force attributable to the flex of the side arm 106a,d.

When the matrix ring 100 is applied to one or more teeth and/or band, the tips 116 deform to the contour of the engaged teeth and spread the forces created by the body 102 across the surface area of those teeth. This force is not distributed evenly. Rather, the force is realized at a tooth or band as varying pressures across the area of contact between a tip front surface 124 and the tooth or band. The pressure provided at any one location on the tip front surface 124 is a function of the proximity to one of the tine finger distal tips 113 and the thickness of the tip 116 at that location to resist deformation.

Prior matrix rings uses tips that have two parts. The first part is a front surface made of soft material configured to contact teeth. The second part was a support for the front surface in order to spread the clamping force generated by the body of the matrix ring across the softer front surface. The matrix ring 100 of this disclosure avoids the need for such a support by distributing the clamping force generated by the body 102 through the first and second tine fingers 112a,b. With a tip formed consistent with the teachings of this disclosure, the first and second tine finger 112a,b distribute the body clamping force sufficiently to allow the soft tips 116 to adequately distribute the clamping force across the surface of one or more teeth and/or a band.

It is known that many human teeth have an outwardly concave curvature from top to bottom on the inner side and/or outer surface. An example of such curvature is depicted in FIG. 5E. This curvature defines a point at which the tooth protrudes the farthest as compared to top of the tooth or at the gingival margin. This point of farthest outward protrusion 608 is referred to herein as the “height of contour.” It has been discovered that locating the maximum pressure created by the matrix ring 100 at or above the height of contour will redirect some of the clamping force upward, increasing the likelihood of spring off of the matrix ring 100 off a patient's teeth. Conversely, locating the maximum pressure created by the matrix ring 100 below the height of contour will redirect some of the clamping force downward, decreasing the likelihood of spring off. Moreover, locating the maximum pressure created by the matrix ring 100 close to the gingival margin 608 and spreading force down to the gingival margin with the tips 116 provides sufficient pressure to any matrix band at the gingival margin to minimize or eliminate any filler material overhang. This minimizes cleanup after the filling procedure.

To avoid this increased likelihood of spring off, the matrix ring 100 of this disclosure is configured to readily facilitate location of the maximum pressure created by the matrix ring 100 below the height of contour 608 and close to the gingival margin. The point of greatest force generated by the body 102 is located at or proximate to the tine finger distal tips 113. The tips 116 are configured to adequately distribute the force generated by the body 102 across the tip front surface 124. In the depicted embodiments, the tips 116 are configured identically to one another, but other configurations are consistent with the teachings of this disclosure.

In the depicted embodiment, the associated tine 108a,b exits the tip 116 through the rear surface 122 (identified in FIG. 5D). The top surface 118 transitions from the rear surface 122 and is angled downwardly approximately parallel with the downward angle of the associated tine 108a,b, which is angled downward at the third angle 304a with respect to horizontal. The depicted and alternative values of the third angle 304a are discussed above. Approximately adjacent to the location where the tine 108a,b split into the first and second tine fingers 112a,b, the top surface 118 curves upwardly to a bulbous transition 130 into the top of the front surface 124. The front surface 124 begins at the distal edge of the tip 126 and is angled outward as it extends upward toward the transition with the top surface 118. The front surface is angled outward with respect to horizontal at a fifth angle 304c. In one embodiment, the fifth angle 304c is approximately 75 degrees.

In the depicted embodiment, the tine gap 114 of each tip 116 bifurcates the entire front surface 124 into two front surface portions, shown as a first front surface portion 206a and a second front surface portion 206b (see, e.g. FIGS. 1B, 2, 5B, 5C). The first front surface portion 206a is provided on the first tip finger 128a and the second front surface portion 206b is provided on the second tip finger 128b. Other embodiments in which only portions of the front surface are separated by the tine gap 114 are also within the scope of this disclosure.

The inner bottom surface 120b extends from the tip distal edge 126 (see, e.g., FIGS. 5C-5D). In the depicted embodiment, the inner bottom surface 120b extends outward approximately horizontal, however other angles with respect to horizontal are within the scope of this disclosure. In the depicted embodiment, the inner bottom surface 120b is approximately flat. The outer bottom surface 120a extends upward from the inner bottom surface 120b approximately parallel to the tine 108a,b to the back surface 122.

As discussed elsewhere, the tip fingers 128a,b of the first tine 108a are configured to engage the outer surface of two adjacent teeth on one side (e.g., outer side) of the teeth and/or a band, and the tip fingers 128a,b of the second tine 108b are configured to engage the outer surface of the two adjacent teeth on the opposite side (e.g., inner side) of the teeth and/or a band. The first tip finger 128a and second tip finger 128b of one of the tips 116 are configured to engage the outer surface of two adjacent teeth (and/or the band), and the first tip finger 128a and the second tip finger 128b of the other one of the tips 116 are configured to engage the inner surface of the two adjacent teeth (and/or the band). Typically, both first tip fingers 128a engage the same tooth (one on the inner side and one on the outer side) and both second tip fingers 128b engage the other tooth (one on the inner side and one on the outer side).

In some embodiments, the first and second front surface portions 206a,b of each tip 116 define a depression 208. In the depicted embodiment, each depression 208 extends from the respective front surface 206a,b to an adjacent side surface 125 of the respective tip finger 128a,b. In the depicted embodiment, each depression 208 defines an inward arcuate curve configured to receive a corresponding outwardly arcuate curve of a patient's tooth, such as when the tine gap 114 is approximately aligned with a tooth gap 604. Other depression configurations are within the scope of this disclosure. As the tips 116 engage the teeth and/or band, the geometry and location of the depressions 208 allows the tips 116 to receive and cradle the teeth.

FIG. 6 is a side view of the matrix ring 100 of FIG. 1B in exemplary placement within a patient's mouth, according to one or more embodiments. More particularly, FIG. 6 depicts a side view of the first side arm 106a and first tine 108a, where the first tip finger 128a of the tip 116 is engaged against a first tooth 602a and the second tip finger 128b of the tip 116 is engaged against a second tooth 602b. While discussion of FIG. 6 depicts the first side arm 106a and first tine 108a, it will be appreciated that the present discussion is equally applicable to the second side arm 106b and second tine 108b.

As depicted in FIG. 6, the first tine 108a may be arranged such that the tine gap 114 substantially aligns with a tooth gap 604 between the adjacent first and second teeth 602a,b. Aligning the tine gap 114 with the tooth gap 604 facilitates the use of a wedge (not shown) configured to extend through the tine gap 114 to be inserted between the adjacent teeth 602a,b within the tooth gap 604. The wedge may be used to assist the band with keeping a filler material (not shown) in or against the tooth being filled, but may also serve to temporarily separate (i.e., wedge open) the adjacent teeth 602a,b. The front surface portions 206a,b of the tip 116 are configured to engage the outer surfaces of adjacent teeth (first and second teeth 602a,b, in FIG. 6). More specifically, the first front surface portion 206a is engaged against the first tooth 602a and the second front surface portion 206b is engaged against the second tooth 602b.

As discussed above, the tips 116 deform when the matrix ring 100 is applied to one or more teeth and/or a band as a result of the clamping force applied by the matrix ring body 102. The pressure provided at any one location on the tip front surface 124 is a function of the proximity to one of the tine finger distal tips 113 and the thickness of the tip at that location to resist deformation. As depicted in FIGS. 5D and 5E, front surface 124 of each tip 116 extends upward from the distal edge 126 forming the fifth angle 304c with respect to horizontal. Stated differently, the front surface 124 extends upward from the distal edge 126 forming an angle with the line of symmetry 111 that is complementary to the fifth angle 304c. In the depicted embodiment, the fifth angle 304c is approximately 75 degrees and so the front surface extends upward from the distal edge 126 at forming an angle of approximately 15 degrees with the line of symmetry 111.

In one embodiment, the fifth angle 304c is designed to be great enough that when the distal edge 126 encounters a tooth below the height of contour 608, that distal edge 126 is subjected to more deformation than any other point in the tip 116. In one embodiment, the deformation imparted to the tip decreases from the distal edge 126 to the portion of the front surface 124 adjacent the tine finger distal tips 113. An exemplary deformation profile 134 is depicted in FIG. 3. The decrease in deformation may be, but need not be, approximately linear. Furthermore, the deformation imparted to the tip 116 above the tine finger distal tips 113 is less than at any point below tine finger distal tips 113. In this embodiment, the distribution of deformation described locates a point of maximum pressure 132 applied by the tips 116 to the tooth below the tine finger distal tips 113. Depending on the curvature and height of the tooth, that point of maximum pressure may be anywhere between the distal edge 126 and the tine finger distal tips 113.

By locating the point of maximum pressure below the tine finger distal tips 113, the point of maximum pressure is located below the height of contour 608 when the tip distal edge 126 is located at the gingival margin 606. The disclosed embodiments of the matrix ring 100 thus direct the clamping force inward and downward on the tooth, toward the gingival margin 606. This tends to reduce the likelihood of the matrix ring 100 springing off.

As discussed above, the fifth angle 304c is 75 degrees in one embodiment. Other values of the fifth angle 304c, and thus the angle the front surface forms with the line of symmetry 111, will also locate the point of maximum pressure below the height of contour 608 and are within the scope of this disclosure. Additionally, the first and second front surface portions 206a,b could define a curve rather than the approximately straight surface depicted and locate the point of maximum pressure below the height of contour 608. Such curved surfaces are also within the scope of this disclosure.

In the depicted embodiment, the distal edge 126 of the tip 116 is configured to engage the first and second teeth 602a,b of a patient approximately at the gingival margin 606. In the depicted embodiment, the tip inner bottom surface 120 extends a small height H below the tine finger distal edges 113. In the depicted embodiment, the height H is smaller than the distance between the gingival margin 606 and the height of contour 608 on a typical human patient for which the matrix ring 100 is intended. This small height H allows a dental professional the ability to use the tip distal edge 126 as a guide and locate that tip distal edge 126 at, or near, the gingival margin 606, knowing that the point of maximum pressure generated by the matrix ring 100 is located below the height of contour 608. In one embodiment, the height H is 0.087 inches. Different sized matrix rings 100 may have different sized bodies 102 and/or tips 116 to fit the size of the patient's mouth. In other embodiments, the height H could be larger than the distance between the gingival margin 606 and the height of contour 608 for the patient.

The matrix ring body 102 gradually reduces the cross-sectional area of the first and second side arms 106a,b from the yoke 104 to the first and second tines 108a,b. More specifically, the first side arm 106a extends from the yoke 104 with a first cross-section defining a first cross-sectional area to the tine where the first side arm 106a has a second cross-section defining a second cross-sectional area. In the depicted embodiment, the matrix ring body 102 has a rectangular cross-section and is of approximately even thickness (from top to bottom) throughout. However, the side arms 106a,b continually generally decrease in width along their lengths as they extend from the yoke 104 toward the tines 108a,b with the sole exception of the boss 115 located on each side arm 106a,b. The term “generally” here meant to exclude one or more protrusions such as the spreader boss 115. As the width of the side arms 106a,b decreases, so does the cross-sectional area. It has been found that in this configuration, stress concentrations in the matrix ring body 102 are minimized. Both fatigue and yield of the body 102 are reduced in a corresponding fashion. The matrix ring 100 can therefore be used repeatedly without failure or significant loss in clamping force. Other manners of reducing the cross-sectional area along the length of the side arms 106a,b are also within the scope of this disclosure. For example, the thickness could be reduced in addition to, or instead of, reducing the width. Other configurations are also contemplated, including, but not limited to, a different cross-sectional shape such as circular or other rounded cross-section. It is furthermore believed that the generally rectangular configuration of the body 102 also contributes to minimizing stress concentrations, fatigue and yield.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A matrix ring comprising:
a body that includes:
a yoke;
a first side arm extending from a first end of the yoke;
a second side arm extending from a second end of the yoke;
a first tine extending downwardly and inwardly from the first side arm, the first tine being bifurcated into a first tip finger and a second tip finger to define a first tine gap; and
a second tine extending downwardly and inwardly from the second side arm and converging toward the first tine, the second tine being bifurcated into a third tip finger and a fourth tip finger to define a second tine gap;
a first tip covering at least a portion of the first tine; and
a second tip covering at least a portion of the second tine.

2. The matrix ring of claim 1, wherein the body comprises a material selected from the group consisting of super elastic BB nitinol, stainless steel and titanium.

3. The matrix ring of claim 1, wherein the first and second tips each comprise a material selected from the group consisting of silicone, liquid silicone rubber, polypropylene or nylon.

4. The matrix ring of claim 1, wherein the yoke comprises an arcuate transition member forming a convex curve between the first and second side arms.

5. The matrix ring of claim 1, wherein the first side arm extends substantially parallel to the second side arm.

6. The matrix ring of claim 1, wherein the first and second side arms extend from the yoke at a first angle, and first and second tines extend from the first and second side arms, respectively, at a second angle, and wherein the first and second angles range between 75° and 105°.

7. The matrix ring of claim 1, wherein the first and second side arms each include a first curve and a second curve, and wherein the first curve is convex and the second curve is concave.

8. The matrix ring of claim 1, wherein the first and second tips each comprise a top surface that transitions into a front surface, and a back surface that transitions into a bottom surface, and wherein the bottom surface and the front surface of each tip converge toward each other until terminating at a distal edge.

9. The matrix ring of claim 8, wherein the entire front surface portion is bifurcated into a first front surface portion defined on the first tip finger and a second front surface portion defined on the second tip finger.

10. The matrix ring of claim 8, wherein the top surface of each tip is angled downwardly at a first angle relative to horizontal and the front surface is angled downwardly at a second angle relative to horizontal, and wherein the second angle is greater than the first angle.

11. The matrix ring of claim 8, wherein the back surface of each tip is angled downwardly at an angle relative to horizontal and the bottom surface extends parallel with horizontal.

12. The matrix ring of claim 1, wherein
the body defines two halves having mirror symmetry of one another about a line of symmetry; and
the first tip comprising a front surface configured to contact one or more teeth or a band, the front surface forming an angle of approximately 15 degrees with the line of symmetry.

13. The matrix ring of claim 1, the first tip comprising a front surface configured to contact one or more teeth or a band and a bottom surface forming an angle of approximately 75 degrees with the front surface at the distal edge.

14. A tip configured for an arm of a matrix ring, the tip comprising:
a top surface that transitions into a front surface configured to contact one or more teeth or a band; and
a back surface that transitions into a bottom surface;
wherein the bottom surface and the front surface meet at a distal edge.

15. The tip of claim 14, wherein the entire front surface portion is bifurcated into a first front surface portion and a second front surface portion, defining a gap there between.

16. The tip of claim 14, wherein an inwardly concave depression is defined at a lateral edge on at least one of the first front surface portion and the second front surface portion.

17. The tip of claim 14, wherein the top surface is angled downwardly at a first angle relative to horizontal and the front surface is angled downwardly at a second angle relative to horizontal, and wherein the second angle is greater than the first angle.

18. The tip of claim 14, wherein the back surface of each tip is angled downwardly at an angle relative to horizontal and the bottom surface extends substantially parallel with horizontal.

19. The tip of claim 14, the bottom surface meets the front surface at angle of approximately 75 degree to form the distal edge.

20. The tip of claim 14 configured for association with a matrix ring body defining two halves having mirror symmetry of one another about a line of symmetry and the front surface forming an angle of approximately 15 degrees with the line of symmetry.

21. The tip of claim 14 comprised of a material selected from the group consisting of silicone, liquid silicone rubber, polypropylene or nylon.

22. A matrix ring comprising:
a body that includes a yoke,
a first side arm extending from a first end of the yoke, the first side arm defining a first curve extending from adjacent to the first end of the yoke and a second curve extending from adjacent to the first curve, the first curve of the first side arm is upwardly convex and the second curve of the first side arm is downwardly convex; and
a second side arm extending from a second end of the yoke, the second side arm defining a first curve extending from adjacent to the second end of the yoke and a second curve extending from adjacent to the second side arm first curve, the first curve of the second side arm is upwardly convex and the second curve of the second side arm is downwardly convex.

23. The matrix ring of claim 22, wherein the yoke defines an arcuate transition member.

24. The matrix ring of claim 22 further comprising a first tine extending from the first side arm, the first tine being bifurcated into a first tip finger and a second tip finger to define a first tine gap.

25. The matrix ring of claim 22, the body comprised of a material selected from the group consisting of super elastic BB nitinol, stainless steel and titanium.

26. The matrix ring of claim 22, the first side arm being substantially parallel to the second side arm.

27. The matrix ring of claim 22, the first and second side arms extend from the yoke at a first angle, and first and second tines extend from the first and second side arms, respectively, at a second angle, and wherein the first and second angles range between 75° and 105°.

28. The matrix ring of claim 22, the first curve of the first side arm has a radius of curvature of approximately 0.122 inches and the second curve of the first side arm has a radius of curvature of approximately 0.122 inches.

29. The matrix ring of claim 22, the first and second curves of the first side arm space the yoke 0.20 inches from a distal end of the second curve of the first side arm.

30. A matrix ring comprising:
a body having a first side arm terminating in a first distal tip and a second side arm terminating in a second distal tip;
a first tip covering the first distal tip of the first side arm, the first tip defining a front surface configured to contact one or more teeth;
a second tip covering the second distal tip of the second side arm, the second tip defining a front surface configured to contact one or more teeth;
the first tip begin configured such that the maximum pressure applied by the first tip front surface to the one or more teeth is located below the first distal tip.

31. The matrix ring of claim 30, the second tip being configured such that the maximum pressure applied by the second tip front surface is located below the second distal tip.

32. The matrix ring of claim 30, the first distal tip being defined by a first tine bifurcated into a first tip finger and a second tip finger to define a first tine gap.

33. The matrix ring of claim 30, the body defining two halves having mirror symmetry of one another about a line of symmetry, and the first tip front surface an angle of approximately 15 degrees with the line of symmetry.

34. The matrix ring of claim 30, the first tip defining a bottom surface forming an angle of approximately 75 degrees with the front surface at a distal edge of the first tip.

35. The matrix ring of claim 30, wherein the body comprises a material selected from the group consisting of super elastic BB nitinol, stainless steel and titanium.

36. The matrix ring of claim 30, wherein the first tip comprises a material selected from the group consisting of silicone, liquid silicone rubber, polypropylene or nylon.

37. The matrix ring of claim 30, wherein the first tip defines a top surface that transitions into the front surface, and a back surface that transitions into a bottom surface, and the bottom surface and the front surface converge toward each other until terminating at a distal edge.

38. The matrix ring of claim 37, the bottom surface and front surface forming an angle of approximately 75 degrees at the distal edge.

39. The matrix ring of claim 32, wherein the entire front surface of the first tip is bifurcated into a first front surface portion defined on the first tip finger and a second front surface portion defined on the second tip finger.

40. A matrix ring comprising:
a body comprising:
a yoke;
a first side arm extending from a first end of the yoke to a first tine and defining a first cross-sectional area adjacent the yoke and a second cross-sectional area adjacent the first tine, wherein the second cross-sectional area is smaller than the first cross-sectional area;
a second side arm extending from a second end of the yoke to a second tine and defining a third cross-sectional area adjacent the yoke and a fourth cross-sectional area adjacent the second tine, wherein the fourth cross-sectional area is smaller than the third cross-sectional area;
a first tip covering the first tine, the first tip defining a front surface configured to contact one or more teeth; and
a second tip covering the second tine, the second tip defining a front surface configured to contact one or more teeth.

41. The matrix ring of claim 40, the cross-sectional area of the first arm continually decreasing from the first cross-sectional area to the second cross-sectional area.

42. The matrix ring of claim 41, the cross-sectional area of the second arm continually decreasing from the third cross-sectional area to the fourth cross-sectional area.

43. The matrix ring of claim 40, wherein the yoke comprises an arcuate transition member forming a convex curve between the first and second side arms.

44. The matrix ring of claim 40, the first tine being bifurcated into a first finger and a second finger to define a first tine gap and the second tine being bifurcated into a third finger and a fourth finger to define a second tine gap.

45. The matrix ring of claim 40, wherein the body comprises a material selected from the group consisting of BB nitinol, stainless steel and titanium.

46. The matrix ring of claim 40, wherein the first side arm extends substantially parallel to the second side arm.

47. The matrix ring of claim 40, wherein the first and second side arms extend from the yoke at a first angle, and first and second tines extend from the first and second side arms, respectively, at a second angle, and wherein the first and second angles range between 75 degrees and 105 degrees.

48. The matrix ring of claim 40, wherein the first and second side arms each include a first curve and a second curve, and wherein the first curve is convex and the second curve is concave.

49. A method of replacing tips on a matrix ring comprising a body having a first side arm having a first tip for contacting teeth and a second side arm having a second tip for contacting teeth, the method comprising the steps of:
i) removing the first tip from the first side arm; and
ii) securing a replacement tip to the first side arm.

50. The method of claim 49, wherein the step of removing the first tip from the first side arm comprises at least cutting the first tip from the first arm.

51. The method of claim 49, wherein the step of removing the first tip from the first side arm comprises at least melting the first tip from the first arm.

52. The method of claim 49, wherein the step of securing a replacement tip to the first side arm comprises at least overmolding the replacement tip to the first side arm.

53. The method of claim 49, wherein the step of securing a replacement tip to the first side arm comprises securing a replacement tip comprising the same material and configuration as the first tip.

54. The method of claim 49, wherein the step of securing a replacement tip to the first side arm comprises securing a replacement tip comprising a configuration different from the configuration of the first tip.
